(19) United States
(12) Patent Application Publication
(10) Pub. No.: US 2013/0088221 A1
(43) Pub. Date: Apr. 11, 2013

(54) DETECTION OF MAGNETIC PARTICLES AND THEIR CLUSTERING

(71) Applicants: Joannes Baptist Adrianus Dionisius Van Zon, Waalre (NL); Mkhail Mikhaylovich Ovsyanko, Eindhoven (NL); Toon Hendrik Evers, Eindhoven (NL); Mara Johanna Jacoba Sijbers, Helden (NL)

(72) Inventors: Joannes Baptist Adrianus Dionisius Van Zon, Waalre (NL); Mkhail Mikhaylovich Ovsyanko, Eindhoven (NL); Toon Hendrik Evers, Eindhoven (NL); Mara Johanna Jacoba Sijbers, Helden (NL)

(73) Assignee: KONINKLIJKE PHILIPS ELECTRONICS N.V., EINDHOVEN (NL)

(21) Appl. No.: 13/705,000

(22) PCT Filed: Nov. 30, 2010
(86) PCT No.: PCT/IB2010/055495

§ 371 Date: Dec. 18, 2012

(30) Foreign Application Priority Data
Jun. 22, 2010 (EP) 10166839.0

(51) Int. Cl. G01N 27/72

(52) U.S. Cl. CPC G01N 27/72
USPC 324/228; 324/244; 356/213; 356/445

(57) ABSTRACT

The invention relates to a method and associated apparatuses (100) for the detection of magnetic particles (MP) in a sample chamber (111). The method comprises the determination of a “particle-parameter” that is related to the amount of magnetic particles (MP) in a first detection region (P, C), the determination of a “cluster-parameter” that is related to the degree of clustering of magnetic particles (MP) in a second detection region (P, C), and the evaluation of the particle-parameter based on the cluster-parameter. Various apparatuses are disclosed that can be applied in said method. In one apparatus (100), a magnetic field (B) is generated in the sample chamber (111) in such a way that it has different inclinations in a first and second field region (P, C) and/or that it is oblique to the binding surface (112) in at least one field region. Magnetic particles (MP) are then detected in said first and second field region and/or in said at least one field region before and after a permanent switch-off of the inclined magnetic field. The resulting detection signals are related to each other to determine a cluster-parameter. In other embodiments, a cluster-parameter may be determined from light transmission measurements during the application of a magnetic field that is switched on and off.

### FIELD OF THE INVENTION

The invention relates to apparatuses and methods for the detection of magnetic particles in a sample chamber.

### BACKGROUND OF THE INVENTION

Magnetic particles are for example used in biosensors to label components of a sample one is interested in. Typical examples of this application are described in the US 2009/148933 A1. According to this document, the magnetization of superparamagnetic beads vanishes when the external magnetic field is switched off, such that these particles do not agglomerate ([0102]).

### SUMMARY OF THE INVENTION

Based on this background, it was an object of the present invention to provide means that allow for a more robust and accurate detection of magnetic particles.

This object is achieved by a method according to claim 1 and apparatuses according to claims 4 to 6. Preferred embodiments are disclosed in the dependent claims.

According to a first aspect, the invention relates to a “basic method” for the detection of magnetic particles in a sample chamber, wherein the term “magnetic particles” shall denote permanently magnetic particles or magnetizable particles, particularly nano-particles or micro-particles. In many cases the magnetic particles are used as labels, i.e. they are bound to some target component (e.g. molecule) one is actually interested in. The “sample chamber” is typically a cavity, particularly an open cavity, a closed cavity, or a cavity connected to other cavities by fluid connection channels. The method shall comprise the following steps, which may be executed in the listed or any other appropriate order:

a) The determination of a parameter, called “particle-parameter” in the following, that is related to the amount of magnetic particles in a first detection region. The “amount of magnetic particles” may be expressed by any appropriate definition, including absolute values (e.g. of the total number or total mass of magnetic particles) and relative values (e.g. the number or mass of magnetic particles per unit volume or area).

b) The determination of a parameter, called “cluster-parameter” in the following, that is related to the amount or degree of clustering of magnetic particles in a second detection region. The “degree of clustering” may be expressed by any appropriate definition (e.g. as the average number or mass of magnetic particles per cluster), including any parameter that depends on particle clustering.

The first and the second detection regions are typically sub-regions of the sample chamber. They may be identical, partially overlapping, or distinct. Moreover, they may comprise the whole sample chamber.

c) The evaluation of the particle-parameter based on the cluster-parameter. This evaluation may for example be done automatically in a data processing device, which may be built from dedicated electronic hardware, digital data processing hardware with appropriate software, or a mixture of both.

The method has the advantage that it provides, additionally to the detection of magnetic particles in a sample, an information about a possible clustering of said particles. This information turns out to be important in practice as the outcome of the particle detection process is often affected by the presence of clusters of magnetic particles. A detection method that yields correct results if no (irreversible) clustering of magnetic particles exists may for example yield increasingly impaired results the more clustering of magnetic particles occurs. Determining the degree of such clustering can hence be used to improve the reliability, robustness and/or accuracy of the particle detection.

The information about the particle-parameter and the cluster-parameter can be exploited for different purposes. In a preferred embodiment, a warning signal is generated if the cluster-parameter deviates from a predetermined set of values, i.e. a predetermined “normal range”. The user can thus be informed that exceptional conditions prevail which impair the reliability of the particle detection results and which may for example necessitate a change in the operating parameters.

According to another embodiment, the particle-parameter may be corrected based on the cluster-parameter. This approach requires that some information about the dependence of the particle-parameter on the degree of particle clustering is known, for example from theoretical considerations or calibration procedures.

The “basic method” of the invention requires as an essential prerequisite the determination of a particle-parameter (related to the amount of magnetic particles in a first detection region) and a cluster-parameter (related to the degree of clustering in a second detection region). In the following, various apparatuses are described that can be applied in the method to provide these parameters or at least information from which a particle-parameter and a cluster-parameter can be derived (preferably by pure calculations, i.e. without additional measurements). It should be noted, however, that these apparatuses can also be used for other purposes, too.

A first apparatus for an application in the “basic method” comprises the following components:

a) A magnetic field generator for generating a magnetic field in the sample chamber, wherein said field has different inclinations with respect to a binding surface of the sample chamber in a “first field region” and a “second field region” of the binding surface, respectively. The magnetic field generator may for example comprise one or more permanent magnets and/or electromagnets that can selectively be controlled. The different inclinations of the magnetic field in the first and second field region are preferably assumed simultaneously, though in general they may also be assumed sequentially (i.e. during partially overlapping or even distinct time intervals). Moreover, the first and the second field region are preferably distinct, though in general they may also be partially overlapping or even identical (wherein the magnetic fields with different inclinations have to be applied sequentially in those parts of the field regions that overlap). Furthermore, the “binding surface” shall in general be an interface between the sample chamber and an adjacent component at/near which the magnetic particles can reside. As its name indicates, there will preferably be some kind of linkage or binding between said “binding” surface and the magnetic particles.

b) A sensor element for detecting magnetic particles (separately) in the first and in the second field region, wherein the sensor element produces detection signals corresponding to its detection results.

c) An evaluation unit for relating the detection signals of the first and the second field regions that are provided by the aforementioned sensor element to each other. The evaluation unit may be realized in dedicated electronic hardware, digital data processing hardware with associated software, or a mixture of both. The relating of the detection signals may for instance comprise the calculation of their ratio, difference, or any other function of these two variables.

Related to the described first apparatus is a method comprising the following steps:

a) Generating a magnetic field in the sample chamber, wherein said field has different inclinations with respect to a binding surface of the sample chamber in a first field region and a second field region of the binding surface, respectively.

b) Detecting magnetic particles in the first and the second field regions.

c) Relating the detection signals originating from the first and the second field region to each other.

The described first apparatus and the corresponding method allow for the manipulation of magnetic particles by a magnetic field and for the detection of these particles at the binding surface. A specific feature is that the applied magnetic field has at least two different inclinations in two regions of the binding surface and that magnetic particles in these regions are separately detected, which allows to relate the resulting detection signals to each other. It turns out that this approach yields valuable additional information about the conditions at the binding surface. In particular, it is possible to obtain information about a possible (irreversible) clustering of the magnetic particles, because said clustering is sensitive to the direction of the magnetic field. Hence it is possible to derive a “particle-parameter” and a “cluster-parameter” from the detection signals.

It should be noted that the “detection regions” of the “basic method” and the “field regions” occurring in the above apparatus are different concepts. In a typical embodiment, the first and second detection regions are identical and correspond to the union of the first and the second field region. This means that the “particle-parameter” and the “cluster-parameter” are determined for the same sub-region of the sample chamber by means of a differentiation of this sub-region into a first and a second field region.

A second apparatus for an application in the “basic method” comprises the following components:

a) A magnetic field generator for generating a magnetic field in the sample chamber that is oblique to the binding surface in a “first” field region of a binding surface of the sample chamber. In this context, a magnetic field is considered to be “oblique” to a surface if it is not parallel to that surface, i.e. if the angle a between the field and the surface fulfills 0°α≦90°.

b) A sensor element for detecting magnetic particles in said first field region, wherein the sensor element produces detection signals corresponding to its detection results.

c) An evaluation unit for relating the detection signals obtained before and after a permanent switch-off of said magnetic field. In this context, the switching-off of a magnetic field is considered to be “permanent” if its duration is longer than a predetermined time interval that is related to the relaxation and diffusion processes at the binding surface. For magnetic particles with a diameter of about 500 nm, a “permanent” switch-off may typically be assumed if its lasts for more than one minute, preferably longer than two minutes. For larger (more heavy) particles (e.g. 1000 nm beads) the required minimal times may be shorter because the larger gravitational force will drive the particles quicker to the surface.

The second apparatus may optionally comprise the features of the first apparatus (in this case the terms “first field region” may refer to the same region). In general, explanations given above with respect to the first apparatus apply analogously also to the second apparatus.

Related to the described second apparatus is a method comprising the following steps:

a) Generating a magnetic field in a sample chamber that is oblique to a binding surface in a “first” field region of the binding surface.

b) Detecting magnetic particles in the first field region.

c) Relating the detection signals obtained before and after a permanent switch-off of said magnetic field.

The second apparatus and the corresponding method allow for the manipulation of magnetic particles by a magnetic field and for the detection of these particles at the binding surface. A specific feature of the second apparatus and method is that the magnetic field shall be oblique to the binding surface and that the detection signals before and after the action of this field are detected and related to each other. It turns out that this approach provides valuable additional information about the conditions at the binding surface, particularly about a possible (irreversible) clustering of magnetic particles. Again, this information can be used to derive a “particle-parameter” and a “cluster-parameter”.

In the first field region of the first or second apparatus, the magnetic field preferably includes an angle of more than about 10° with respect the binding surface. In this case the magnetic field is sufficiently oblique to the binding surface to reveal clustering effects of magnetic particles.

In the second field region (if present), the magnetic field preferably includes an angle of less than about 10° with respect to the binding surface, more preferably of less than about 5°. Such a magnetic field can be considered as substantially being parallel to the binding surface in the second field region. Diffusion related effects of the clustering of magnetic particles are minimized in this configuration.

A third apparatus for an application in the “basic method” comprises the following components:

a) A “particle detection unit” for detecting magnetic particles in the first detection region of the sample chamber. The particle detection unit typically generates a signal (e.g. an electrical signal) that is associated to the detection result, representing for example the amount of detected magnetic particles as some analogue value. This signal may hence directly correspond to the particle-parameter required by the method of the invention.

The particle detection unit may apply any appropriate detection principle, for example optical, magnetic, mechanical, acoustic, thermal and/or electrical. Most preferably, the particle detection unit will be surface sensitive, i.e. detect magnetic particles only within a limited region close to the surface of the sample chamber.

b) A “cluster detection unit” for detecting the degree of clustering of magnetic particles. Again, the cluster detection unit typically generates a signal (e.g. an electrical signal) that is associated to the detection result and that may directly correspond to the cluster-parameter required by the method of the invention.

There are different ways how the presence of clusters can be detected. In a preferred embodiment, the cluster detection unit may for example comprise a light source and a light detector that are arranged to measure the light transmission in the second detection region. For non-spherical clusters comprising a plurality of magnetic particles, for example chains of magnetic particles that are aligned to an external magnetic field, the light transmission will typically depend on the occurrence and degree of clustering. A transmission measurement thus provides an appropriate means to determine a cluster-parameter.

In the aforementioned case, the cluster detection unit may preferably comprise at least one reflective and/or at least one refractive interface that is encountered by light on its way from the light source to the light detector. A reflective surface (mirror) can for example be used on one side of the sample chamber to reflect light back towards the side of the light source, thus allowing to arrange the light source and the light detector on the same side of the sample chamber. Similarly, refractive windows on sides faces of the sample chamber may be used to redirect light such that the light source and/or the light detector can be arranged at convenient locations.

The method and the apparatuses according to the invention may preferably comprise a magnetic field generator, for example a permanent magnet or an electromagnet, for generating a magnetic field in the sample chamber that acts on the magnetic particles.

The magnetic field generator may preferably comprise a horse-shoe magnet. This provides configurations of a well-defined behavior with which a magnetic field of different inclinations can readily be generated (e.g. having a larger inclination near the pole tips and an approximately parallel direction between them). Additionally or alternatively, the magnetic field generator may comprise a magnet that is positioned opposite to a sensor element.

A magnetic field in the sample chamber may serve various purposes, which usually comprise an interaction with the magnetic particles. In many important applications, the magnetic field is configured in such a way that it generates forces on the magnetic particles, particularly forces that are attractive towards a binding surface. To this end, the magnetic field will usually have a gradient to produce the desired direction of the force. The attraction of magnetic particles towards a binding surface can be used to accelerate their migration from the whole sample volume into much smaller regions where they are detected. During the action of a magnetic field, clusters or chains of magnetic particles are usually formed, which may persist after the field has been switched off. This (undesirable) irreversible clustering can be dealt with by the determination of the cluster-parameter.

According to a further development of the embodiment with a magnetic field generator, the magnetic field is modulated, particularly switched on and off repetitively. Hence the effect of the magnetic field on magnetic particles alternates with periods during which the particles are free from external magnetic influences. If the magnetic field exerts a force on the magnetic particles, this means for example that a forced movement of the particles alternates with free (diffusion controlled) migration. It should be noted that the switching-off of the magnetic field that is meant in this context is usually shorter than the “permanent” switching-off defined above.

The frequency of the repetitive switching-off of the magnetic field preferably ranges between about 10 Hz and about 0.1 Hz (wherein the period of this switching is defined as the time between two consecutive switching-on events).

The duty cycle of the repetitive switching-off of the magnetic field preferably ranges between about 20% and about 90%, wherein said duty cycle is defined as the duration of the “on” interval with respect to the whole switching period (comprising both the “on” and “off” interval). Via the duty cycle it can be controlled how much time the magnetic particles have to freely migrate without the influence of a magnetic field. If clustering of the magnetic particles occurs in the magnetic field and if the clusters are oriented oblique to a binding surface, the available time for a field-free migration determines if distal magnetic particles or sub-clusters have enough time to reach the binding surface by diffusion or not. The value of the duty cycle may hence crucially influence the outcome of the detection procedure. This dependency can for instance be used to determine if the clustering is reversible (no sub-clusters occur after switching-off of the magnetic field) or irreversible (sub-clusters occur).

The described switching of the magnetic field may particularly take place during the detection of the particle-parameter and/or the cluster-parameter. As explained above, clusters of magnetic particles that form due to the action of a magnetic field will usually disintegrate due to thermal motion as soon as the magnetic field is switched off. In case of a permanent or irreversible clustering, the magnetically formed clusters of particles may however persist for whatever reason (e.g. due to chemical bindings). The action of a modulated magnetic field can therefore be used to distinguish between reversible and irreversible clustering of magnetic particles and to determine a degree of (irreversible) clustering.

The aforementioned distinction between reversible and irreversible clustering may be inferred from a variety of different measurements. Most preferably, the detection signal of the cluster detection unit may be evaluated with respect to a local relative amplitude, i.e. with respect to the relative difference between the nearest local maximum and the nearest local minimum at some point in time, wherein said local extrema are assumed when the magnetic field the switch on or off, respectively.

In a preferred embodiment of the invention, the sample chamber comprises a binding surface that is covered with binding sites for the magnetic particles. It should be noted in this context that the magnetic particles may often contain specifically bound target components (e.g. biomolecules) from a sample to be examined, and that the binding to the binding sites may occur via these target components. The binding sites may accordingly be “specific” in the sense that they only bind magnetic particles of a certain population, particularly magnetic particles that comprise the mentioned target components.

The detection of magnetic particles, if it is part of the method or the apparatuses, may be achieved by any suitable method or principle, for example by optical, magnetic, mechanical, acoustic, thermal and/or electrical measurements. The detection signal will typically be an electrical signal or a computer generated signal (resulting e.g. from image processing) representing a scalar value that is related to the amount of magnetic particles in the corresponding sensing region.

The invention further relates to the use of the apparatuses described above for molecular diagnostics, biological sample analysis, chemical sample analysis, food analysis, and/or forensic analysis. Molecular diagnostics may for example be accomplished with the help of magnetic beads or fluorescent particles that are directly or indirectly attached to target molecules.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 schematically shows a side view of a (first/second) apparatus according to the present invention;

FIG. 2 separately illustrates the configuration of the magnetic field in the apparatus of FIG. 1;

FIG. 3 illustrates the partial breakdown of a cluster of magnetic particles after switching-off of the magnetic field;

FIG. 4 is a diagram showing measurement results in a first and second field region for pulsed magnetic fields with 40% duty cycle when a reversible clustering of beads occurs;

FIG. 5 is a diagram like FIG. 4 for 90% duty cycle when a reversible clustering of beads occurs;

FIG. 6 is a diagram like FIG. 4 for 40% duty cycle when an irreversible clustering of beads occurs;

FIG. 7 is a diagram like FIG. 4 for 90% duty cycle when an irreversible clustering of beads occurs;

FIG. 8 schematically illustrates a (third) apparatus according to the invention with a cluster detection unit applying light transmission from the top side to the bottom side of the sample chamber;

FIG. 9 shows a modification of the apparatus of FIG. 8, applying light transmission from the bottom side of the sample chamber to the top side and back;

FIG. 10 shows a modification of the apparatus of FIG. 8, applying light transmission with a refraction of light at opposite side windows of the sample chamber;

FIG. 11 illustrates light transmission measurement signals obtained at different locations on the surface of the sample chamber and for a plurality of on/off switching periods of the magnetic field for a sample with no clustering;

FIG. 12 illustrates measurement signals as in FIG. 11 for a sample with clustering;

FIG. 13 schematically illustrates with higher temporal resolution the time course of a light transmission measurement signal when a magnetic field is switched on and after it is switched off;

FIG. 14 is a diagram relating the determined clustering to particle detection results;

FIG. 15 shows the course of relative amplitudes of detection signals in samples with and without analyte-induced clustering.

Like reference numbers or numbers differing by integer multiples of 100 refer in the Figures to identical or similar components.

### DESCRIPTION OF PREFERRED EMBODIMENTS

The invention will in the following be described with respect to biological or healthcare applications, comprising for example the detection of DNA (molecular diagnostics) and proteins (immuno-assays), both important markers for all kinds of diseases in the human body. Immuno-assay techniques may use small (super)paramagnetic beads to selectively capture the biological markers of interest. Subsequently the magnetic beads can couple to specific antibody sites on the surface, followed by a registration of the beads for the final detection. Based on this platform detection instruments can be developed for decentralized measurements such as the roadside testing of Drugs-Of-Abuse in saliva or the Point-Of-Care testing of cardiac markers in human blood at the physicians place.

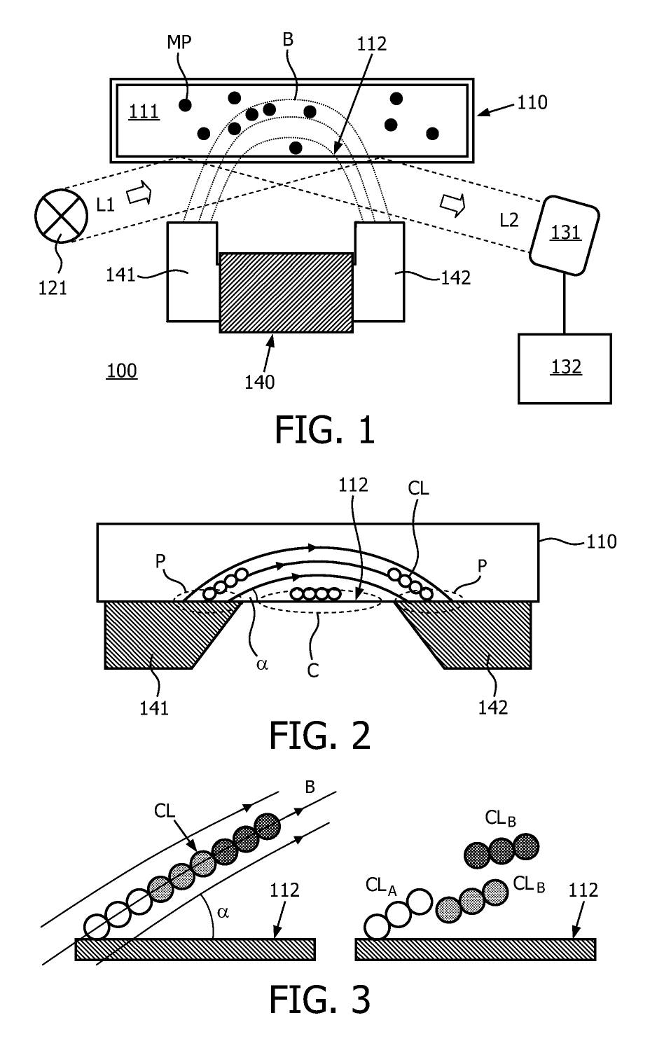

As an example of the aforementioned instruments, FIG. 1 schematically shows an apparatus 100 for the optical detection of magnetic particles MP provided in a cartridge or carrier 110. As the carrier is contaminated by the sample at hand, it will usually be a disposable device, produced for example from glass or transparent plastic (e.g. poly-styrene) by injection moulding. Moreover, the carrier 110 may logically be considered as a part of the apparatus 100 or not.

The carrier 110 comprises a sample chamber 111 in which a sample fluid with target components to be detected (e.g. drugs, antibodies, DNA, etc.) can be provided. The sample further comprises magnetic particles MP, for example superparamagnetic beads, wherein these particles MP are usually bound as labels to the aforementioned target components (for simplicity only the magnetic particles MP are shown in the Figures). The bottom interface between the massive part of the carrier 110 and the sample chamber 111 is formed by a surface called “binding surface” 112. This binding surface 112 may optionally be coated with capture elements, e.g. antibodies, which can specifically bind the target components.

The apparatus 100 comprises a light source 121 (e.g. a red 650 nm LED) for emitting an “input light beam” L1 into the carrier 110. The input light beam L1 arrives at the binding surface 112 at an angle larger than the critical angle of total internal reflection (TIR) and is therefore totally internally reflected as an “output light beam” L2. The output light beam L2 leaves the carrier 110 and is detected by a light detector, e. g. by the light-sensitive pixels of a camera 131. The light detector 131 thus generates detection signals representing the amount of light of the output light beam L2 (e.g. expressed by the light intensity of this light in the whole spectrum or a certain part of the spectrum). An evaluation unit 132 receives the detection signals from the light detector for further processing (evaluation, recording etc.).

The apparatus 100 further comprises a magnetic field generator 140 for controllably generating a magnetic field B at the binding surface 112 and in the adjacent space of the sample chamber 111. The magnetic field generator may for example be realized by an electromagnet 140 with a coil and a horse-shoe core having two pole tips 141 and 142. It may optionally comprise further magnetic units, for example a (e.g. cylindrical) magnet above the cartridge 110 (not shown), which commonly generate a magnetic field by superposition. With the help of the generated magnetic field, the magnetic particles MP can be manipulated, i.e. be magnetized and particularly be moved (if magnetic fields with gradients are used). Thus it is for example possible to attract magnetic particles MP to the binding surface 112 in order to accelerate the binding of the associated target component to said surface.

The described apparatus 100 applies optical means for the detection of magnetic particles MP and the target components one is actually interested in. For eliminating or at least minimizing the influence of background (e.g. of the sample fluid, such as saliva, blood, etc.), the detection technique should be surface-specific. As indicated above, this is achieved by using the principle of frustrated total internal reflection. This principle is based on the fact that an evanescent wave propagates (exponentially dropping) into the sample chamber 111 when the incident light beam L1 is totally internally reflected. If this evanescent wave then interacts with another medium having a different refractive index from water like the magnetic particles MP, part of the input light will be coupled into the sample fluid (this is called “frustrated total internal reflection”), and the reflected intensity will be reduced (while the reflected intensity will be 100% for a clean interface and no interaction). Further details of this procedure may be found in the WO 2008/155723 A1, which is incorporated into the present text by reference.

A problem with which an apparatus of the kind described above has to deal is that body-fluids like saliva and blood (or plasma) show large differences in physical and chemical properties from patient to patient. Preferably the assay and the actuation techniques used in a bio sensor should be robust against these variations.

A related problem is the irreversible clustering of the magnetic particles. Because a magnetic field B is used to attract the magnetic particles MP towards the binding surface 112, the magnetic particles MP become magnetized and also start attracting each other. Chains of magnetic clusters are formed. This effect can be clearly observed under a microscope with sufficient magnification. The chains are held together by the magnetic forces which the magnetic particles MP exert onto each other (the so-called bead-bead interactions). When the magnetic actuation field B is switched off, the magnetic particles are not magnetized anymore (if they are superparamagnetic) and the magnetic forces which hold together the chains disappear. Under normal circumstances the chains disintegrate into individually moving beads again. This process is referred to as “reversible clustering” or magnetic clustering: the magnetic field causes magnetic clustering but once the magnetic field is switched off, the clusters disappear again.

In contrast to reversible or magnetic clustering, also irreversible clustering is possible. There are various ways of irreversible clustering: irreversible clustering can take place in the absence of a magnetic field (cf. colloid chemistry) or it can be triggered by the presence of a magnetic field. In the case of irreversible clustering, the clusters do not disintegrate to individually moving beads when the magnetic field is switched off. The amount of irreversible clustering is strongly dependent of the composition of the body fluid and can vary a lot from patient to patient. The real mechanism for this irreversible clustering is not yet understood.

In general, the signal measured by an apparatus like that of FIG. 1 is proportional to the concentration of target molecules to be detected. This is the main function of the apparatus. A high signal indicates a high concentration of target molecules and a low signal indicates a low concentration of target molecules. However experiments have also shown that the measured signal is influenced by the amount of irreversible clustering. A combination of a high concentration of target molecules and a large amount of irreversible clustering will give rise to a lower signal. Therefore irreversible clustering leads to a misinterpretation of the measured signal. For many diseases a high concentration of a certain species (such as the cardiac marker) indicates that there is a malfunction in the body. When a low signal is indicated by the instrument, the malfunction is not noticed. This poses a problem.

In the following, various approaches will be disclosed which determine a “cluster-parameter” that is related to the degree of (irreversible) clustering. The cluster-parameter can for example be used to emit a warning if the measured signal is probably not reliable, or to correct measurement results.

In FIGS. 1 to 7, a first approach is described in which the dependence of the behavior of magnetic particles and of clusters on the orientation of magnetic fields is exploited.

In order to understand the proposed solution, first the process of binding functional magnetic particles MP to the binding surface 112 will be explained in a little more detail with reference to FIGS. 2 and 3.

As a starting point it is assumed that the sample fluid above the measurement spot contains magnetic particles MP (typically superparamagnetic beads) with target molecules attached to them. It will not further be described here how this incubation reaction is carried out. In order to measure the concentration of magnetic particles with a target molecule, these particles have to bind to antibodies printed on the binding surface 112. These antibodies specifically catch the target molecules. The kinetics of this binding reaction between the target and the antibody can by speeded up by enhancing the concentration of targets near the surface. This is done by means of the magnetic field B. When the magnetic field B is switched on, a magnetic force (perpendicular to the binding surface) drives the magnetic particles MP from the liquid towards the binding surface 112 where the antibodies are. This process is called the “attraction phase” of the actuation cycle.

An essential aspect of the aforementioned processes is that, although all magnetic particles (with or without target) are attracted by the magnetic field B towards the binding surface, only a small fraction of these particles will actually be in contact with the surface and be able to bind. A first fraction of magnetic particles will bind to the originally empty surface but as soon as a certain surface coverage of magnetic particles is reached, the following arriving magnetic particles will magnetically cluster to the already bound beads. Because the magnetic field normally makes a certain angle a with the binding surface 112 (this angle a being dependent on the location between the poles 141, 142 of the magnet), the distal beads in a cluster CL are outside of the evanescent light field and are invisible to the measurement system. Under a continuous magnetic field B, the fractional surface coverage is about 10% at the center C of the magnet and even lower near in the regions P at the pole tips 141, 142 of the magnet (cf. FIG. 2).

In order to allow the magnetically clustered beads to reach the binding surface 112 and bind, the magnetic field B is switched off after the first attraction phase. In this case the clusters CL can disintegrate into individually moving beads of which a part can reach the binding surface by diffusion. This is called the “diffusion phase” of the actuation cycle. Another fraction of the beads will diffuse into the liquid channel. This fraction can be brought back to the surface by switching the magnetic field B on again. By repetitively switching the magnetic field B on and off (the total actuation sequence consists of many actuation cycles), finally all magnetic particles have the possibility to bind to the binding surface 112. This is the essence of the described pulsed actuation protocol.

From the previous it will be clear that the largest part of the detection signal (90%) is generated through the process of disintegration of the clusters into individual magnetic particles and the diffusion of free magnetic particles towards the binding surface. FIG. 3 illustrates what happens if an incomplete disintegration occurs after the magnetic field B has been switched off. In the left part of FIG. 3, a whole cluster CL is shown that is oriented along the field lines of the magnetic field B. The right part of FIG. 3 shows the incomplete breakdown of this cluster into sub-clusters CL_{A}, CL_{B} after the magnetic field B has been switched off. Distal magnetic particles belonging to a surface-bound sub-cluster CL_{A} are prevented from reaching the binding surface at all. The longer fragments CL_{B} which are released from the previous cluster show a slower diffusion rate and will have less chance of binding to the surface 112. In the latter case there should be enough free space on the surface to accommodate the larger fragments. These mentioned effects will lead to a lower signal by bound magnetic particles.

The main question is now how to discriminate between a low level of signal due to a low target concentration and a low level due to the effect of irreversible clustering. Normally the surface concentration of bound magnetic particles is measured in the center C of a horseshoe magnet. At this position the highest signals are measured and the reproducibility between spots is the best. However, this approach is also less sensitive to effects of diffusion if a pulsed actuation consisting of a magnetic field on and off is considered because the distance of the formed chains to the binding surface is rather short. In order to better see the effects of diffusion, it is proposed to create a larger average distance between the chains and the binding surface.

The direction of the magnetic field lines B as generated by the horseshoe magnet 140 is more or less in parallel to the binding surface 112. This is exactly true at the center position C of the electromagnet 140 (cf. FIG. 2), where the angle a between the field lines and the binding surface is 0°. At locations P that are closer to one of the pole tips 141, 142 of the electromagnet, the magnetic field lines B start to make a finite angle a with respect to the surface. This is basically because the shape of the fringing field of the horseshoe magnet is more or less shaped as a part of a circle. Close to the pole tip position the angle a can be as large as 30°. In their lowest energy state the chains of magnetic particles are directed parallel to the magnetic field lines B. The average distance between the magnetic particles and the binding surface 112 in the “first field regions P” near the pole tips is thus much larger than in the “second field region C” at the center of the horseshoe magnet. Therefore the signal measured in said first field regions P is much more sensitive to changes in the bead diffusion than the signal at the second field region C. This can be used to detect irreversible clustering.

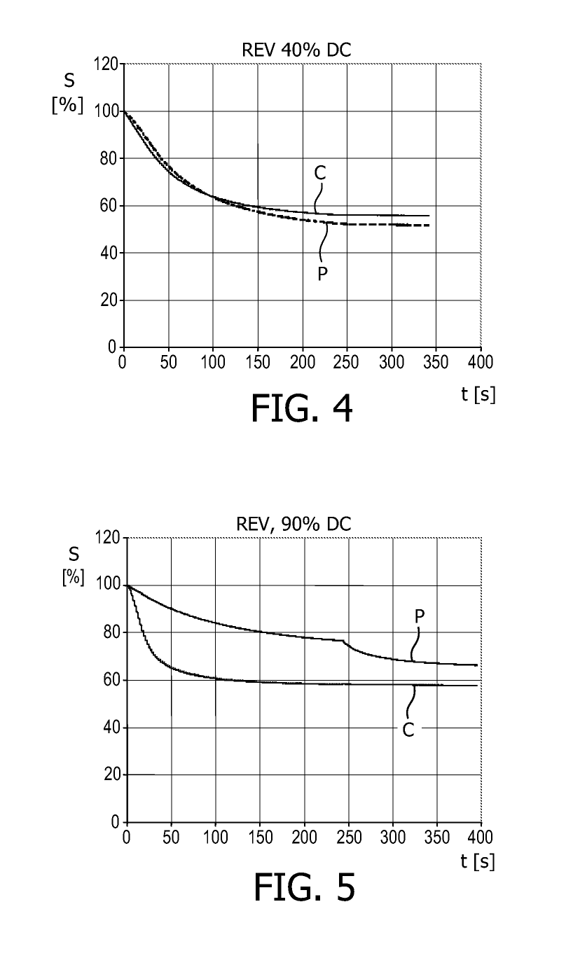

When no irreversible clustering appears, the signals at the center position C and the pole tip position P will be more or less the same. FIG. 4 shows the results of an exemplary measurement with magnetic beads coated with streptavidin showing reversible clustering (here and in the following, the letter C at a curve indicates a measurement at the center position, while P indicates a measurement at the pole tip positions; the vertical axes indicate the detection signals S in relative units, while the horizontal axes represent time t). The “duty cycle” of the actuation cycle indicates the fraction of an actuation cycle during which the magnetic field is switched on (i.e. the duty cycle indicates the relative duration of the “attraction phase”, the residual duration being filled by the “diffusion phase”). This duty cycle is tuned such that enough time for single bead diffusion is given to the position of the pole tip: the magnetic particles at the pole tip have enough time to reach the binding surface and contribute to the detection signal. This is achieved in FIG. 4 by a duty cycle of 40%, which means that 40% of the cycletime the beads are attracted towards the binding surface and 60% of the cycletime the beads diffuse freely in all directions.

In the measurements shown in FIG. 5, the duty cycle has been chosen much higher. In this case 90% of the cycletime is used for attraction and 10% of the cycletime is used for diffusion. The signal measured at the pole tip (upper curve) becomes lower than the signal at the center (bottom curve) because the diffusion time has been chosen too short (it should be noted that the signals S are referred to a starting signal of “100%”; a “lower signal” will therefore be represented by S-values that lie in the diagrams above those of a “higher signal”). The magnetic particles at the pole tip cannot reach the binding surface in time.

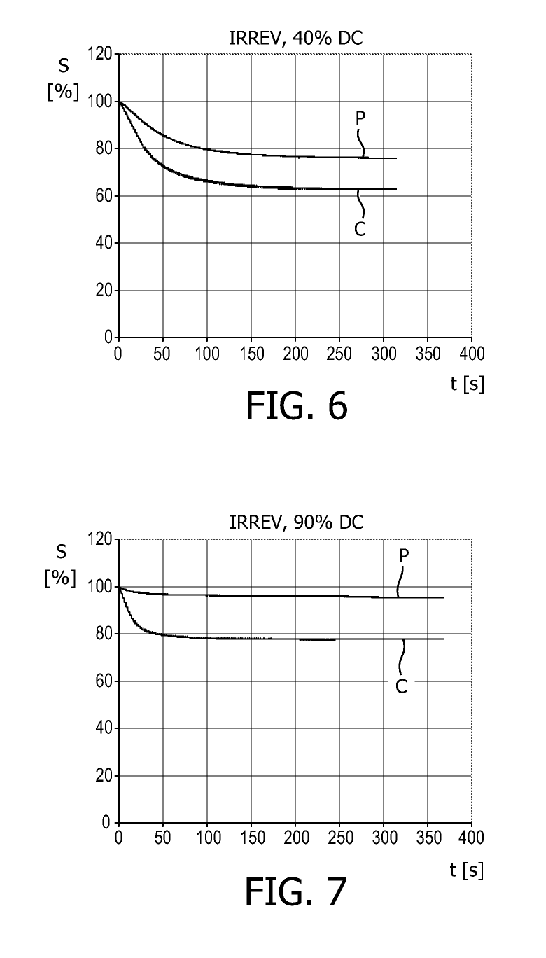

Whenever irreversible clustering appears, the diffusion of the cluster fragments is slowed down because the fragments are larger than single magnetic particles and there is more hydrodynamic resistance from the fluid. FIG. 6 shows measured signals as a function of time t for streptavidin beads showing irreversible clustering. This has also been verified by microscope experiments. The difference in diffusion between single magnetic particles and fragments is less noticeable at the center position C because here the distance which the magnetic particles or fragments have to diffuse is relatively short. As in FIG. 4, the duty cycle is 40%, and for this particular case the signal measured at the center C is slightly less than the corresponding signal in FIG. 4. However, at the pole tip positions P the slower diffusion prevents the fragments from reaching the surface in time, even for a duty cycle of 40%. This is clearly visible if the corresponding curves of FIGS. 6 and 4 are compared. The ratio between the detection signal S obtained in the first field region P at the pole tips and the detection signal S obtained in the second field region at the center C has reduced. This ratio can be used as a measure for the irreversible clustering.

In the measurements shown in FIG. 7, the duty cycle has been chosen at 90% of the cycletime (as in FIG. 5). Due to the insufficient diffusion times, all the detection signals are now lower.

The magnetic force generated by the horseshoe magnet 140 is directed mainly perpendicular to the binding surface 112. The transport of magnetic particles to the center area C of the magnet is more or less equal to the transport of magnetic particles to the pole tip areas P. So basically both areas collect the same amount of beads. When finally the magnetic field is permanently switched off and one waits until the diffusion process has been completed, one would expect the same amount of signal at the pole tip position P and the center position C. In practice this is not always seen because beads also diffuse away from the surface. However, in the case of the reversible clustering it is observed that switching off the pulsed actuation with the 90% duty cycle, gives an extra contribution in the signal near the pole tip (cf. curve “P” in FIG. 5). In this case the beads which could not reach the binding surface in time during the actuation can still reach the surface if enough diffusion time is given. In case of the irreversible clustering such an enhancement in signal is hardly observed (cf. FIG. 7). This extra information also points towards irreversible clustering behavior.

In summary, the measurement of detection signals near the pole tips P of the actuation magnet, where the magnetic field has an inclination with respect to the binding surface, can provide information about the irreversible clustering behavior when compared to the detection signal near the center C of the magnet, where the magnetic field is approximately parallel to the binding surface. The ratio between the detection signal at the pole tips and the detection signal at the center is a measure for the amount of irreversible clustering. Thus a check can be build into a handheld device. A warning can be given by the evaluation unit 132 when irreversible clustering appears to indicate that the measured signal is probably not reliable.

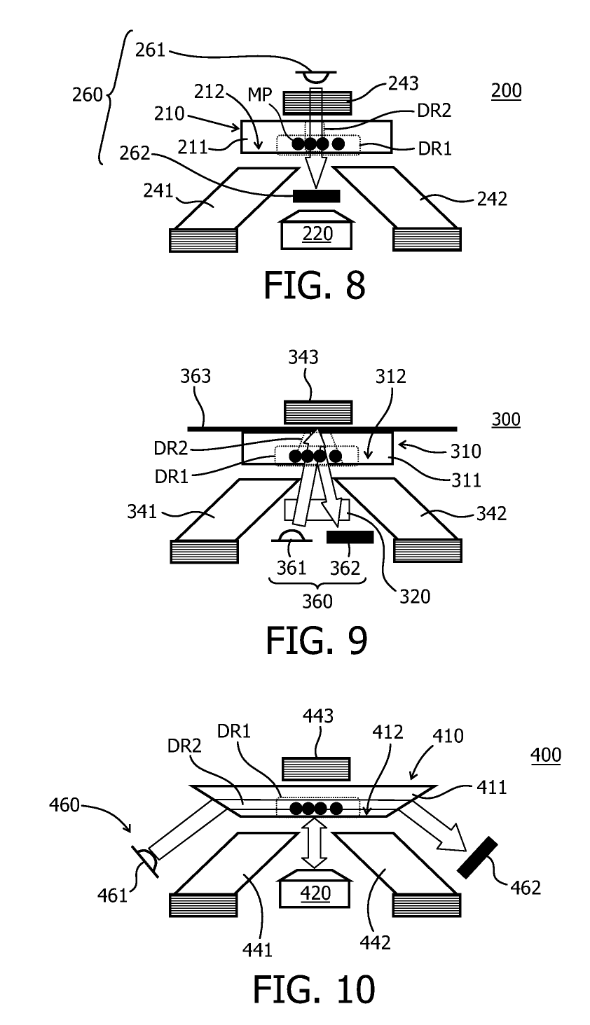

In FIGS. 8 to 14, a second approach is described in which a dedicated cluster detection unit is used to determine a cluster-parameter.

FIG. 8 schematically illustrates a sensor device or apparatus 200 according to this approach. Similar to the embodiments described above, said apparatus serves as a biosensor based on nanoparticle labels, particularly magnetic beads or particles MP, which are provided in a sample chamber 211 of a cartridge 210 and which can be actuated with electromagnetic fields generated by electromagnets 241, 242, and 243. Typically, the magnetic particles are functionalized with antibodies that can bind a specific analyte molecule. During an assay, the particles MP can be magnetically attracted into a “first detection region” DR1 at a “binding surface” 212 of the sample chamber 211, where the number of bound particles is directly or inversely related to the amount of analyte molecules present in the sample. The magnetic particles MP can then be detected by a “particle detection unit” 220 using any technique that is more sensitive to particles that are close to the surface, i.e. that are in the first detection region DR1 (in the Figure, the particle detection unit 220 may be arranged/extend out of the drawing plane to provide it with access to the first detection region DR1 without obstruction by the component 262). For example, the detection technique may be based on evanescent optical fields, e.g. frustrated total internal reflection (FTIR) as described above.

As already explained above, sample fluids like human plasma seem to contain interfering factors that cause the irreversible aggregation (“clustering”) of the magnetic particles MP, which leads to a decreased assay performance. In the case where the analyte is cardiac troponin I for example, this can lead to a false negative result. A way of accurately determining the amount of clustering in a magnetic particle assay would therefore be valuable, either as a control (e.g. to disqualify the outcome of a particular measurement if the amount of clustering exceeds a certain threshold) or as a calibrator: if the relationship between the amount of clustering and the decrease in assay performance is known, the obtained outcome could be corrected and thereby resulting in more accurate measurements.

In the apparatus 200, the aforementioned objective is achieved by the provision of a “cluster detection unit” 260 that allows to determine a “cluster-parameter” related to the degree of clustering of magnetic particles MP in a “second detection region” DR2. In short, light is transmitted through the cartridge 210 containing the sample chamber 211 with a fluid sample in which magnetic nanoparticles MP are dispersed. In the apparatus 200, this is realized in the most straightforward way by placing a light source 261 on one side of the cartridge 210 and collecting the light transmitted through the second detection region DR2 at the other side by a detector 262 (e.g. an image sensor). It is observed that when the magnets 241, 242 are switched on, the intensity recorded by the cluster detection unit 260 increases. When the coils are switched off and the particles redisperse into a random pattern, the intensity decreases again. As will be explained in more detail below, the intensity changes allow to determine the desired “cluster-parameter” (degree of clustering).

The arrangement of the cluster detection unit 260 puts some limitations on the use of the top coil 243, which comprises no core material to allow the passage of light. FIG. 9 shows a modified apparatus 300 in which these limitations are circumvented by using a (non-magnetic) reflecting layer 363, e.g. an aluminum foil, on one side of the cartridge 310 (in the Figure the top side, but it could be the bottom or any other side, too). In this embodiment, light passes the sample in the second detection region DR2 twice. Both the light source 361 and the detector 362 of the cluster detection unit 360 can be positioned at the same side, for example the bottom side of the cartridge 310.

FIG. 10 illustrates a further apparatus 400 in which light emitted by the light source 461 of a cluster detection unit 460 is refracted at a facet of the cartridge 410, travels through the liquid in the second detection region DR2, is refracted again at the opposite facet of the cartridge 410, and arrives at the detector 462.

If it is preferred to analyze only a small portion of a cartridge, this could be done by using a microscope objective at the same or the opposite side as the bottom coils. Besides monitoring changes in the transmitted light intensity, it is of course also possible to position a detector outside the primary light path of the light source, thereby collecting only the scattered light. At low particle concentrations, this could be more favorable as it is difficult to detect very small changes at a high light intensity.

In the apparatuses 200, 300, and 400, the detector 262, 362, or 462 which collects the light is connected to a control unit (not shown) with software which can power the magnetic coils and record the intensity measured by the detector.

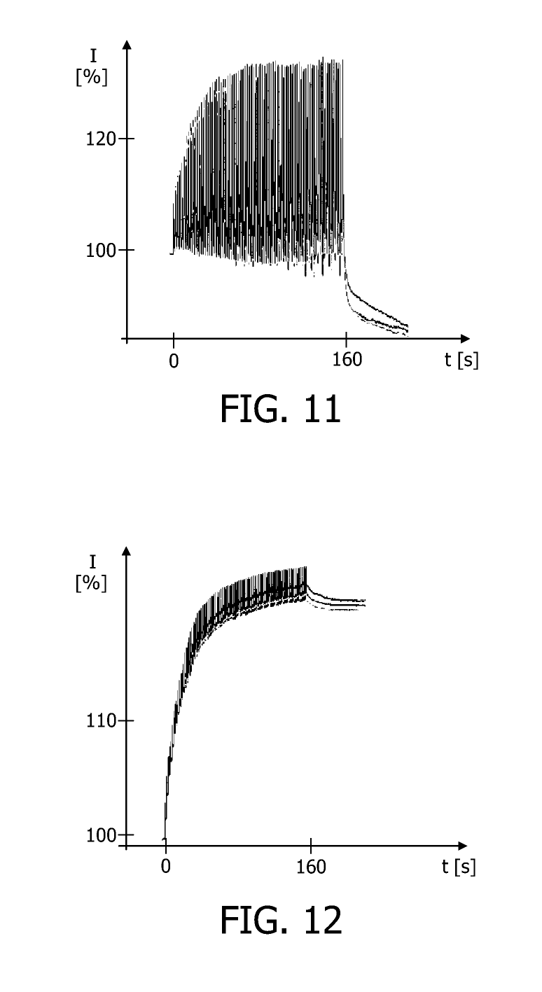

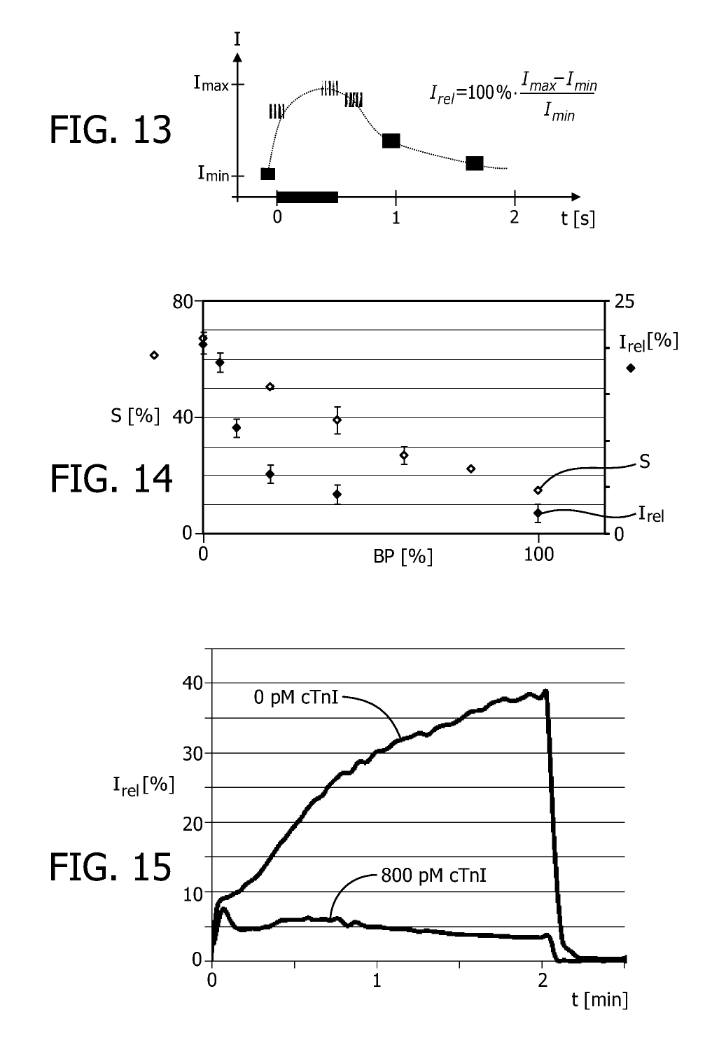

A typical recording of measured transmission intensity I is shown in FIG. 11. The recording was obtained in an experimental setup similar to the apparatus 300 in which light is reflected back through the sample to a detector (image sensor) which records the intensity. The diagram actually comprises three measurement curves obtained at three different locations of the recorded image. During the recordings, the electromagnets were repetitively switched on and off. It is observed that when the magnets are switched on, the magnetic particles align in chains and the recorded intensity increases. When the coils are switched off and the particles redisperse into a random pattern, the intensity decreases again. This is illustrated in more detail in FIG. 13, in which the intensity I is represented (in arbitrary units) on the vertical axis and in which measurement points are indicated by the corresponding microscope images of the detection region. The depicted time span corresponds to one on/off period of the magnets, wherein the magnet is switched on between t=0 s and 0.5 s and off between t=0.5 s and 2 s.

It is observed that when the magnetic particles exhibit (irreversible) clustering, the chains formed during the action of a magnetic field do not (fully) redisperse. While the diagram of FIG. 11 shows an example of signals obtained in a non-clustering sample, FIG. 12 displays the signal changes observed in a sample that exhibits heavy clustering. As can be seen from a comparison of FIGS. 11 and 12, there are many differences between the two obtained curves, for example the increase in the baseline (local minima), the difference in amplitude, and the relaxation time of each individual pulse (not visible at this detail level). Each of these differences can be exploited to quantify the amount of clustering, i.e. a “cluster-parameter”.

Especially the relative amplitude at a given time t proves to provide a robust way of measuring the amount of clustering in a particular sample, this relative amplitude Iᵣₑₗ being defined as

Iᵣₑₗ=100%·(local maximum−local minimum)/local minimum.

FIG. 14 shows measurements of the amount of clustering and assay performance for samples exhibiting different degrees of clustering while containing the same amount of analyte. The assay performance is given as a signal change S, which is defined as the (e.g. FTIR) measurement signal obtained from the particle detection unit (20, 320, 420) at an endpoint, i.e. after a washing step (left axis, open diamonds). The clustering is given as the relative amplitude Iᵣₑₗ (right axis, full diamonds) as measured in the cluster assay, which can be interpreted as a particle mobility: the lower the signal, the lower the mobility (and the higher the degree of clustering). The samples for the measurements were obtained by mixing two samples containing the same amount of analyte, wherein the first sample exhibits no clustering, while the second sample exhibits heavy clustering. The horizontal axis represents the relative amount of second sample, i.e. the percentage BP of clustering-inducing sample.

As can be seen, the higher the percentage BP of clustering-inducing second sample, the lower the signal amplitude S (which means that there is more clustering). It is clear from FIG. 14 that the amount of clustering Iᵣₑₗ and the assay performance S are correlated, wherein this method is very sensitive to the degree of clustering in a sample.

FIG. 14 further shows that the presence of clustering has the result that the measured signal change S in a magnetic label assay does not correctly reflect the real concentration of an analyte in the sample. As mentioned above, a determination of the amount of clustering Iᵣₑₗ can be used under these circumstances in two ways:

1. As a control: if a sample displays clustering above a certain threshold, the measurement is disqualified and the apparatus returns an error message. This is very important to exclude false negatives.

2. As a calibrator: when it is know how a certain amount of clustering leads to a diminished interaction of magnetic particles with the surface (and therefore a decreased end signal), it is possible to correct for this decreased interaction and multiply the result of the signal change (S) with a factor dependent on the amount of clustering (Iᵣₑₗ).

Besides for the unwanted clustering described above, it should be noted that the proposed technique is also able to measure the clustering induced by the presence of a target. As an example, magnetic particles coated with an antibody directed against a first epitope of the cardiac troponin I (cTnI) molecule were mixed with magnetic particles coated with an antibody directed against a second epitope of cTnI. Finally, also cTnI (at a concentration of 800 pM) was added and the complete mixture was analyzed in a cluster assay. As a control, the mixture of both magnetic particles alone (without cTnI) was also analyzed.

Measurement data (comparable to FIGS. 11 and 12) show that the presence of 800 pM cTnI causes severe clustering, as the cTnI molecule can be bound by two particles simultaneously. FIG. 15 shows the temporal course of the relative amplitude Iᵣₑₗ obtained from these measurements.

Because this assay format does not require the binding of the particles to a surface in which often a large part of the particles cannot participate in forming the molecular sandwich, this is a highly efficient assay format. Although 800 pM is still a relatively high concentration, it can be seen from FIG. 15 that at this concentration, the clustering is already very severe. It was observed in FIG. 14 that the cluster assay is already sensitive at a much smaller degree of clustering, and it is therefore expected that it will be possible to measure much more sensitive than shown here. In addition, the assay itself can be further optimized (particle concentration, both antibodies on a single particle, magnetic actuation schemes, etc.)

While the invention was described above with reference to particular embodiments, various modifications and extensions are possible, for example:
The sensor can be any suitable sensor to detect the presence of magnetic particles on or near to a sensor surface, based on any property of the particles, e.g. it can detect via magnetic methods (e.g. magnetoresistive, Hall, coils), optical methods (e.g. imaging, fluorescence, chemiluminescence, absorption, scattering, evanescent field techniques, surface plasmon resonance, Raman, etc.), sonic detection (e.g. surface acoustic wave, bulk acoustic wave, cantilever, quartz crystal etc), electrical detection (e.g. conduction, impedance, amperometric, redox cycling), combinations thereof, etc.
In addition to molecular assays, also larger moieties can be detected with sensor devices according to the invention, e.g. cells, viruses, or fractions of cells or viruses, tissue extract, etc.
The detection can occur with or without scanning of the sensor element with respect to the sensor surface.
Measurement data can be derived as an end-point measurement, as well as by recording signals kinetically or intermittently.
The particles serving as labels can be detected directly by the sensing method. As well, the particles can be further processed prior to detection. An example of further processing is that materials are added or that the (bio)chemical or physical properties of the label are modified to facilitate detection.
The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink-jet printing on a substrate.
The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).
The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.
With nano-particles are meant particles having at least one dimension ranging between 3 nm and 5000 nm, preferably between 10 nm and 3000 nm, more preferred between 50 nm and 1000 nm.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A method for the detection of magnetic particles (MP) in a sample chamber (111, 211, 311, 411), comprising:
a) the determination of a particle-parameter (S) that is related to the amount of magnetic particles (MP) in a first detection region (P, C; DR1);
b) the determination of a cluster-parameter (Iᵣₑₗ) that is related to the degree of clustering of magnetic particles (MP) in a second detection region (P, C; DR2);
c) the evaluation of the particle-parameter based on the cluster-parameter.

2. The method according to claim 1,
characterized in that a warning signal is generated if the cluster-parameter (Iᵣₑₗ) deviates from a predetermined set of values.

3. The method according to claim 1,
characterized in that the particle-parameter (S) is corrected based on the cluster-parameter (Iᵣₑₗ).

4. An apparatus (100) for an application in the method of claim 1, comprising:
a) a magnetic field generator (140) for generating a magnetic field (B) in the sample chamber (111) that has different inclinations with respect to a binding surface (112) of the sample chamber in a first field region (P) and a second field region (C) of the binding surface, respectively;
b) a sensor element (121, 131) for detecting magnetic particles (MP) in the first and the second field region (P, C);
c) an evaluation unit (132) for relating the detection signals of the first and the second field region (P, C) to each other.

5. An apparatus (100) for an application in the method of claim 1, comprising:
a) a magnetic field generator (140) for generating a magnetic field (B) in the sample chamber (111) that is oblique to a binding surface (112) of the sample chamber (111) in a first field region (P) thereof;
b) a sensor element (121, 131) for detecting magnetic particles (MP) in the first field region (P);
c) an evaluation unit (132) for relating the detection signals obtained before and after a permanent deactivation of said magnetic field (B).

6. An apparatus (200, 300, 400) for an application in the method of claim 1, comprising:
a) a particle detection unit (220, 320, 420) for detecting magnetic particles (MP) in the first detection region (DR1);
b) a cluster detection unit (260, 360, 460) for detecting the degree of clustering (Lᵣₑₗ) of magnetic particles (MP) in the second detection region (DR2).

7. The apparatus (200, 300, 400) according to claim 6, characterized in that the cluster detection unit comprises a light source (261, 361, 461) and a light detector (262, 362, 462) arranged to measure light transmission in the second detection region (DR2).

8. The apparatus (300, 400) according to claim 7,
characterized in that the cluster detection unit comprises at least one reflective and/or refractive interface (363) encountered by light on its way from the light source (361, 461) to the light detector (362, 462).

9. The method according to claim 1,
characterized in that there is a magnetic field generator for generating a magnetic field (B) acting on the magnetic particles (MP).

10. The method or the apparatus (100, 200, 300, 400) according to claim 9,
characterized in that the magnetic field (B) generates an attractive force on the magnetic particles (MP) towards a binding surface (112, 212, 312, 412) of the sample chamber (111, 211, 311, 411).

11. The method or the apparatus (100, 200, 300, 400) according to claim 9,
characterized in that the magnetic field (B) is modulated, particularly switched on and off repetitively.

12. The apparatus (200, 300, 400) according to claim 6,
characterized in that the detection signal of the cluster detection unit (260, 360, 460) is evaluated with respect to its local relative amplitude (Iᵣₑₗ).

13. The method according to claim 1,
characterized in that the sample chamber comprises a binding surface that is covered with binding sites for magnetic particles (MP).

14. The method according to claim 1,
characterized in that the magnetic particles (MP) are detected with an optical, magnetic, mechanical, acoustic, thermal or electrical detection procedure.
